(19) United States
(12) Patent Application Publication
(10) Pub. No.: US 2020/0256762 A1
(43) Pub. Date: Aug. 13, 2020

(54) METHOD OF INSPECTING OPTICAL WAVEGUIDE AND METHOD OF MANUFACTURING OPTICAL WAVEGUIDE USING SAME

(71) Applicant: NITTO DENKO CORPORATION, Ibaraki-shi, Osaka (JP)

(72) Inventors: Hiroki Ozawa, Ibaraki-shi (JP); Yuichi Tsujita, Ibaraki-shi (JP); Akira Arima, Ibaraki-shi (JP)

(73) Assignee: NITTO DENKO CORPORATION, Ibaraki-shi, Osaka (JP)

(21) Appl. No.: 15/776,198

(22) PCT Filed: Dec. 8, 2016
(86) PCT No.: PCT/JP2016/086486

§ 371 Date: May 15, 2018

(30) Foreign Application Priority Data
Dec. 17, 2015 (JP) 2015-246120

(51) Int. Cl. G01M 11/00; G02B 6/42

(52) U.S. Cl. CPC G01M 11/31; G02B 6/4214

(57) ABSTRACT

There are provided methods of inspecting an optical waveguide including inspecting the degree of curvature of a light reflecting surface formed in a core of the optical waveguide, and of manufacturing an optical waveguide using the same. In the method of inspecting an optical waveguide, light enters the core of the optical waveguide via a connection surface in a second end portion of the core, to reflect from light reflecting surfaces in a first end portion of the core and to exit the optical waveguide, and the exiting light is imaged by a camera. Then, the brightness of the exiting light is measured by determining the brightness of the obtained image. The degree of curvature of the light reflecting surfaces decreases as the measurement value of brightness increases. Thus, an optical waveguide having a brightness greater than a reference value has light reflecting surfaces which are nearly flat.

### TECHNICAL FIELD

The present disclosure relates to a method of inspecting an optical waveguide for use in the fields of optical communications, optical information processing and other general optics, and to a method of manufacturing an optical waveguide using the same.

### BACKGROUND ART

With the increase in the amount of transmission information, optical interconnect lines in addition to electrical interconnect lines have been used in recent electronic devices and the like. As an example, an opto-electric hybrid board in which an electric circuit board E having an electrical interconnect line 52 and an optical waveguide W having a core (optical interconnect line) 57 are stacked together and in which a light-emitting element 11 and a light-receiving element 12 are mounted on portions of the electric circuit board E which correspond to opposite end portions of the optical waveguide W has been proposed, as shown in FIG. 7 (see PTL 1, for example). In this opto-electric hybrid board, the electric circuit board E is configured such that the electrical interconnect line 52 is formed on a front surface of an insulative layer 51. The optical waveguide W is configured such that the core (optical interconnect line) 57 is held between a first cladding layer 56 and a second cladding layer 58. The first cladding layer 56 of the optical waveguide W is in contact with a back surface (a surface opposite from the surface with the electrical interconnect line 52 formed thereon) of the insulative layer 51 of the electric circuit board E. The opposite end portions of the optical waveguide W which correspond to the light-emitting element 11 and the light-receiving element 12 are formed into inclined surfaces inclined at 45 degrees with respect to the longitudinal direction of the core 57 (a direction in which light propagates). Portions of the core 57 positioned at the inclined surfaces function as light reflecting surfaces 57a and 57b. Portions of the insulative layer 51 which correspond to the light-emitting element 11 and the light-receiving element 12 have respective through holes 55 for an optical path. The through holes 55 allow light L to propagate therethrough between the light-emitting element 11 and the light reflecting surface 57a in a first end portion (a left-hand end portion as seen in FIG. 7) and between the light-receiving element 12 and the light reflecting surface 57b in a second end portion (a right-hand end portion as seen in FIG. 7).

The propagation of the light L in the aforementioned opto-electric hybrid board is performed in a manner to be described below. First, the light L is emitted from the light-emitting element 11 toward the light reflecting surface 57a in the first end portion. The light L passes through one of the through holes 55 for an optical path formed in the insulative layer 51, and then passes through the first cladding layer 56. Then, the light L is reflected from the light reflecting surface 57a in the first end portion of the core 57 (the optical path is changed by 90 degrees), and travels through the interior of the core 57 in the longitudinal direction thereof. Then, the light L propagated in the core 57 is reflected from the light reflecting surface 57b in the second end portion of the core 57 (the optical path is changed by 90 degrees), and travels toward the light-receiving element 12. Subsequently, the light L passes through the first cladding layer 56 and exits the first cladding layer 56. Then, the light L passes through the other of the through holes 55 for an optical path formed in the insulative layer 51, and is received by the light-receiving element 12.

In the opto-electric hybrid board, it is important that the light L reflected from the light reflecting surface 57b in the second end portion of the core 57 is properly received by the light-receiving element 12. To this end, conventional methods have been proposed which inspect the inclination angle of the light reflecting surface 57b to judge only a product including the light reflecting surface 57b having a proper inclination angle as an accepted product (see PTL 2 and PTL 3, for example).

### RELATED ART DOCUMENT

### Patent Document

PTL 1: JP-A-2009-288341

PTL 2: JP-A-HEI7(1995)-234118

PTL 3: JP-A-2014-199229

### SUMMARY OF INVENTION

However, there have been some individual products in which the amount of light received by the light-receiving element 12 is small although the light reflecting surface 57b has a proper inclination angle. As a result of the investigation into the cause of this phenomenon, the present inventors have found that, in the products in which the amount of light received by the light-receiving element 12 is small, the light reflecting surfaces 57a and 57b in the opposite end portions of the core 57 are curved to have a low degree of flatness. It has hence been found that the light L reflected from the light reflecting surfaces 57a and 57b is not reflected in a designed direction but is scattered, so that the amount of light L reaching a light-receiving portion of the light-receiving element 12 is small. That is, the present inventors have found out that not only the inclination angle of the light reflecting surfaces 57a and 57b but also the degree of curvature (the degree of flatness) of the light reflecting surfaces 57a and 57b is significantly concerned with the propagation of light.

The degree of curvature of the light reflecting surfaces 57a and 57b can be inspected by scanning the light reflecting surfaces 57a and 57b with laser light to acquire an image of the light reflecting surfaces 57a and 57b and then analyzing the image. However, the inspection is neither simple nor easy. A conventional method of inspecting the degree of curvature of the light reflecting surfaces 57a and 57b in a simple and easy manner has not yet been proposed.

In view of the foregoing, it is therefore an object of the present disclosure to provide a method of inspecting an optical waveguide which is capable of inspecting the degree of curvature (the degree of flatness) of a light reflecting surface formed in a core of the optical waveguide in a simple and easy manner, and a method of manufacturing an optical waveguide using the same.

To accomplish the aforementioned object, a first aspect of the present disclosure is intended fora method of inspecting an optical waveguide. The method comprises the steps of: preparing an optical waveguide including a linear core for an optical path, the core having a first end portion in which a light reflecting surface for changing an optical path is formed; and causing light to enter the core by way of a second end portion of the core, to reflect from the light reflecting surface and to exit the optical waveguide, and then measuring a brightness of the exiting light, wherein the degree of curvature of the light reflecting surface is inspected based on a measurement value of the brightness.

A second aspect of the present disclosure is intended for a method of manufacturing an optical waveguide. The method comprises the steps of: forming a core; forming a first end portion of the core into a light reflecting surface; and inspecting the degree of curvature of the light reflecting surface through the use of the aforementioned method of inspecting an optical waveguide, wherein an optical waveguide meeting a standard is judged as an accepted product, based on a result of the inspection.

For the purpose of achieving the inspection of the degree of curvature of the light reflecting surface formed in the core of the optical waveguide in a simple and easy manner, the present inventors have made studies about light exiting the optical waveguide after being reflected from the light reflecting surface. As a result, the present inventors have found out that there is a correlation between the degree of curvature of the light reflecting surface and the magnitude of the brightness of the exiting light. Specifically, as the degree of curvature of the light reflecting surface increases (the degree of flatness thereof decreases), the extent of spread of the light reflected from the light reflecting surface increases, and the brightness of the light exiting the optical waveguide accordingly decreases. Conversely, as the degree of curvature of the light reflecting surface decreases (the flatness thereof increases), the extent of spread of the light reflected from the light reflecting surface decreases, and the brightness of the light exiting the optical waveguide accordingly increases. Thus, the present inventors have found that the measurement of the magnitude of the brightness of the light exiting the optical waveguide enables the inspection of the degree of curvature of the light reflecting surface in a simple and easy manner based on the measurement value of brightness.

In the method of inspecting an optical waveguide according to the present disclosure, light is caused to reflect from the light reflecting surface formed in the core of the optical waveguide and thereafter to exit the optical waveguide. Then, the brightness of the exiting light is measured. There is a correlation between the degree of curvature (the degree of flatness) of the light reflecting surface and the magnitude of the brightness of the exiting light. For this reason, the measurement of the magnitude of the brightness of the light exiting the optical waveguide enables the inspection of the degree of curvature (the degree of flatness) of the light reflecting surface in a simple and easy manner based on the measurement value of brightness.

In particular, in the case where a reference value of the brightness is previously set and the measurement value of the brightness is compared with the reference value in the curvature inspection based on the measurement value of the brightness, whether the measurement value of the brightness is greater or smaller than the reference value is easily judged. This achieves the inspection of the degree of curvature of the light reflecting surface in a simpler and easier manner.

Further, in the case where the measurement of the brightness in the step of measuring the brightness is made by using a camera including an imaging device to image the light exiting the optical waveguide by means of the imaging device while the focus of the camera is adjusted to a portion of the light reflecting surface (in a focused state), and then determining a brightness of an obtained image, the image of the light exiting the optical waveguide which is imaged by the imaging device becomes sharp and accordingly has a smaller area.

Also, in the case where the measurement of the brightness in the step of measuring the brightness is made by using a camera including an imaging device to image the light exiting the optical waveguide by means of the imaging device while the focus of the camera is shifted away from the light reflecting surface (in a defocused state), and then determining a brightness of an obtained image, the image of the light exiting the optical waveguide which is imaged by the imaging device becomes blurred and accordingly has a larger area. A difference between the measurement value of brightness of the exiting light reflected from the light reflecting surface having a high degree of curvature which is measured in the defocused state and the reference value of the brightness is greater than that measured in the focused state. Thus, it is easily recognized that the degree of curvature of the light reflecting surface is high.

In the method of manufacturing an optical waveguide according to the present disclosure, the first end portion of the core is formed into a light reflecting surface, and thereafter the degree of curvature of the light reflecting surface is inspected through the use of the aforementioned method of inspecting an optical waveguide. This allows shipment of only accepted products meeting a standard as commodity products by excluding products having a high degree of curvature of the light reflecting surface. As a result, the reliability of quality of the optical waveguide is improved.

### BRIEF DESCRIPTION OF DRAWINGS

FIG. 1 is a schematic vertical sectional view of one embodiment of opto-electric hybrid boards including an optical waveguide to be inspected by a method of inspecting an optical waveguide according to the present disclosure.

FIGS. 2A to 2C are illustrations schematically showing the steps of forming an electrical circuit board in the opto-electric hybrid boards, and FIG. 2D is an illustration schematically showing the step of forming a metal layer in the opto-electric hybrid boards.

FIGS. 3A to 3D are illustrations schematically showing the steps of forming the optical waveguide in the opto-electric hybrid boards.

FIG. 4 is an illustration schematically showing one embodiment of the method of inspecting an optical waveguide.

FIG. 5 is a schematic vertical sectional view of another embodiment of the opto-electric hybrid boards including the optical waveguide to be inspected by the method of inspecting an optical waveguide according to the present disclosure.

FIG. 6 is an illustration schematically showing another embodiment of the method of inspecting an optical waveguide.

FIG. 7 is a schematic vertical sectional view of a conventional opto-electric hybrid board.

### DESCRIPTION OF EMBODIMENTS

Next, embodiments according to the present disclosure will now be described in detail with reference to the drawings.

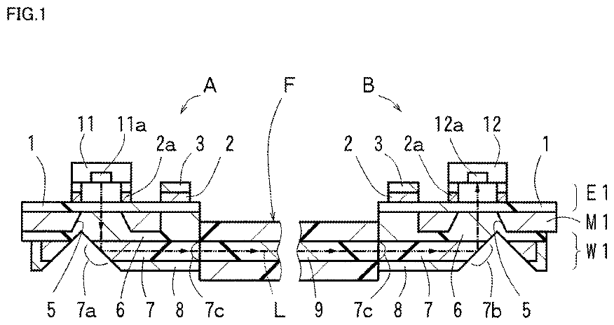

FIG. 1 is a vertical sectional view of one embodiment of opto-electric hybrid boards including an optical waveguide to be inspected by a method of inspecting an optical waveguide according to the present disclosure. As shown in FIG. 1, opto-electric hybrid boards A and B according to this embodiment are used while being connected to opposite end portions of an optical fiber F. The opto-electric hybrid boards A and B and the optical fiber F form an opto-electric hybrid module. The opto-electric hybrid boards A and B in opposite end portions of this opto-electric hybrid module include: an optical waveguide W1 for connection to an end portion of the optical fiber F; an electric circuit board E1 stacked on the optical waveguide W1; and optical elements 11 and 12 mounted on portions of the electric circuit board E1 which correspond to first end portions of the optical waveguide W1. The optical elements 11 and 12 include a light-emitting element 11 provided in the opto-electric hybrid board A in a first end portion (a left-hand end portion as seen in FIG. 1) of the opto-electric hybrid module, and a light-receiving element 12 provided in the opto-electric hybrid board B in a second end portion (a right-hand end portion as seen in FIG. 1) of the opto-electric hybrid module. In this embodiment, a metal layer M1 for reinforcement is further provided in portions which lie between the electric circuit board E1 and the optical waveguide W1 and which correspond to mounting pads 2a on which the light-emitting element 11 and the light-receiving element 12 are mounted.

More specifically, the electric circuit board E1 includes: a light-permeable insulative layer 1; electrical interconnect lines formed on a front surface of the insulative layer 1 and having an electrical interconnect line body 2 and the mounting pads 2a; and a coverlay 3 covering the electrical interconnect line body 2.

The optical waveguide W1 includes: a first cladding layer 6; a second cladding layer 8; and linear core 7 for an optical path held between the first cladding layer 6 and the second cladding layer 8. The first end portions of the optical waveguide W1 which correspond to the light-emitting element 11 and the light-receiving element 12 are formed into inclined surfaces inclined at 45 degrees with respect to the longitudinal direction of the core 7. Portions of the core 7 positioned at the inclined surfaces function as light reflecting surfaces 7a and 7b. That is, in the opto-electric hybrid board A in the first end portion (the left-hand end portion as seen in FIG. 1) of the opto-electric hybrid module, the light reflecting surface 7a reflects light L to allow light propagation between the light-emitting element 11 and the core 7. In the opto-electric hybrid board B in the second end portion (the right-hand end portion as seen in FIG. 1) of the opto-electric hybrid module, the light reflecting surface 7b reflects light L to allow light propagation between the light-receiving element 12 and the core 7. Second end portions (end portions opposite from the light reflecting surfaces 7a and 7b) of the optical waveguide W1 are formed into perpendicular surfaces perpendicular to the longitudinal direction of the core 7. Portions of the core 7 positioned at the perpendicular surfaces function as connection surfaces 7c for connection to end surfaces of a core 9 of the optical fiber F.

The metal layer M1 is disposed between the insulative layer 1 of the electric circuit board E1 and the first cladding layer 6 of the optical waveguide W1. Through holes 5 for an optical path are formed in portions of the metal layer M1 which correspond to locations lying between the light-emitting element 11 and the light reflecting surface 7a and between the light-receiving element 12 and the light reflecting surface 7b.

The propagation of light in the aforementioned opto-electric hybrid module is performed in a manner to be described below. First, in the opto-electric hybrid board A in the first end portion (the left-hand end portion as seen in FIG. 1) of the opto-electric hybrid module, light L is emitted from a light-emitting portion 11a of the light-emitting element 11 toward the light reflecting surface 7a in a first end portion of the core 7. The light L passes through the insulative layer 1, through one of the through holes 5 for an optical path formed in the metal layer M1 and through the first cladding layer 6 in the order named, and then enters the core 7. Subsequently, the light L is reflected from the light reflecting surface 7a in the first end portion of the core 7, so that the optical path of the light L is changed by 90 degrees. Then, the light L is propagated in the core 7 to one of the connection surfaces 7c in a second end portion of the core 7, and thereafter exits the one connection surface 7c. Subsequently, the light L enters the core 9 of the optical fiber F by way of a first end portion (a left-hand end portion as seen in FIG. 1) of the core 9 of the optical fiber F. Then, the light L is propagated in the core 9 of the optical fiber F to a second end portion (a right-hand end portion as seen in FIG. 1) of the core 9, and thereafter exits the second end portion thereof. Subsequently, in the opto-electric hybrid board B in the second end portion (the right-hand end portion as seen in FIG. 1) of the opto-electric hybrid module, the light L enters the core 7 by way of the other connection surface 7c in the second end portion of the core 7. Subsequently, the light L is propagated to the light reflecting surface 7b in the first end portion of the core 7, and is reflected from the light reflecting surface 7b, so that the optical path of the light L is changed by 90 degrees. Then, the light L is propagated toward the light-receiving element 12. Subsequently, the light L exits the core 7, and passes through the first cladding layer 6, through the other through hole 5 for an optical path formed in the metal layer M1 and through the insulative layer 1 in the order named. Then, the light L is received by a light-receiving portion 12a of the light-receiving element 12.

The core 7 has a refractive index exceeding 1.0. Air is present outside the light reflecting surfaces 7a and 7b, and has a refractive index of 1.0. In this manner, the refractive index of the core 7 is higher than that of the outside air. Thus, the light L is not transmitted through the light reflecting surfaces 7a and 7b but is reflected from the light reflecting surfaces 7a and 7b.

In this manner, in the opto-electric hybrid board A in the first end portion (the left-hand end portion as seen in FIG. 1) of the opto-electric hybrid module, it is important that the light L reflected from the light reflecting surface 7a in the first end portion of the core 7 is properly propagated in the core 7 to the one connection surface 7c in the second end portion of the core 7 without leaking from the core 7. Also, in the opto-electric hybrid board B in the second end portion (the right-hand end portion as seen in FIG. 1) of the opto-electric hybrid module, it is important that the light L reflected from the light reflecting surface 7b in the first end portion of the core 7 is properly received by the light-receiving portion 12a of the light-receiving element 12. If the light reflecting surfaces 7a and 7b are curved to have a low degree of flatness, the light L reflected from the light reflecting surfaces 7a and 7b is not reflected in a designed direction. This causes the light L reflected from the light reflecting surface 7a to leak from the core 7 in the opto-electric hybrid board A in the first end portion (the left-hand end portion as seen in FIG. 1) of the opto-electric hybrid module, and also precludes the light L reflected from the light reflecting surface 7b from being properly received by the light-receiving portion 12a of the light-receiving element 12 in the opto-electric hybrid board B in the second end portion (the right-hand end portion as seen in FIG. 1) of the opto-electric hybrid module. In these cases, the opto-electric hybrid boards A and B, which cannot fulfill their functions, are discarded. The discarding of the opto-electric hybrid boards A and B results in great losses because the light-emitting element 11 and the light-receiving element 12 which function normally are also discarded.

For this reason, the degree of curvature (the degree of flatness) of the light reflecting surfaces 7a and 7b of the optical waveguide W1 is inspected in this embodiment prior to the mounting of the light-emitting element 11 and the light-receiving element 12 in the steps of producing the opto-electric hybrid boards A and B, which will be described below.

Specifically, the production of the opto-electric hybrid boards A and B including the aforementioned inspection step is performed in a manner to be described below.

[Formation of Electric Circuit Board E1 of Opto-Electric Hybrid Boards A and B]

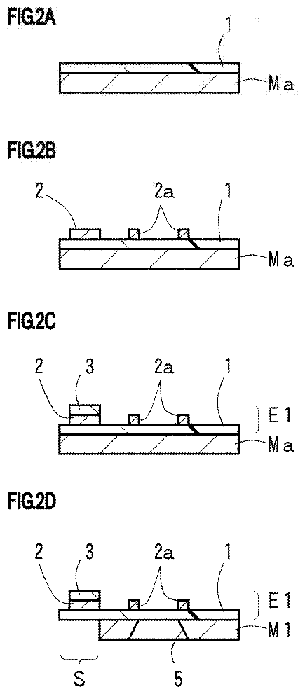

First, a metal sheet material Ma (with reference to FIG. 2A) for the formation of the metal layer M is prepared. Examples of a material for the formation of the metal sheet material Ma include stainless steel and alloy of iron and nickel (a content of the nickel is 42%). In particular, stainless steel is preferable from the viewpoint of dimensional accuracy and the like. The metal sheet material Ma (the metal layer M1) has a thickness in the range of 10 to 100 μm, for example.

Next, as shown in FIG. 2A, a photosensitive insulating resin is applied to a front surface of the metal sheet material Ma to form the insulative layer 1 having a predetermined pattern by a photolithographic process. Examples of a material for the formation of the insulative layer 1 include synthetic resins such as polyimide, polyether nitrile, polyether sulfone, polyethylene terephthalate, polyethylene naphthalate and polyvinyl chloride, and silicone-base sol-gel materials. The insulative layer 1 has a thickness in the range of 10 to 100 μm, for example.

Next, as shown in FIG. 2B, the electrical interconnect lines (the electrical interconnect line body 2 and the mounting pads 2a) are formed by a semi-additive process or a subtractive process, for example.

Next, as shown in FIG. 2C, a photosensitive insulating resin including a polyimide resin or the like is applied to a portion of the electrical interconnect line body 2 to thereby form the coverlay 3 by a photolithographic process. In this manner, the electric circuit board E1 is formed on the front surface of the metal sheet material Ma.

[Formation of Metal Layer M1 of Opto-Electric Hybrid Boards A and B]

Thereafter, as shown in FIG. 2D, etching or the like is performed on the metal sheet material Ma to remove a portion S on a longitudinally front end portion (second end portion) side of the metal sheet material Ma and to form the through hole 5 for an optical path in the metal sheet material Ma. In this manner, the metal sheet material Ma is formed into the metal layer M1.

[Formation of Optical Waveguide W1 of Opto-Electric Hybrid Boards A and B]

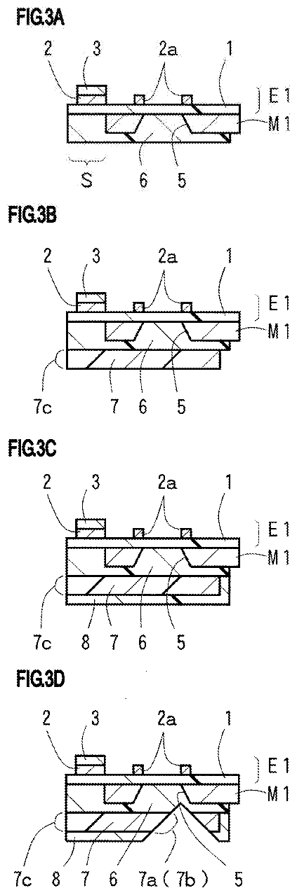

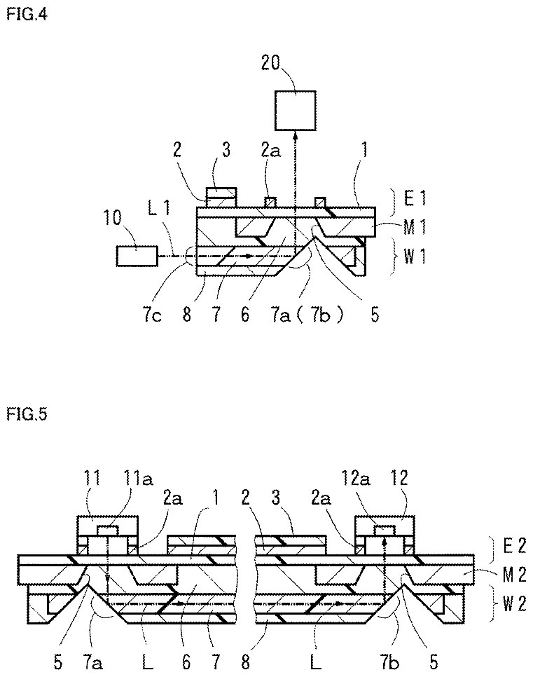

For the formation of the optical waveguide W1 (with reference to FIG. 4) on a back surface of a laminate comprised of the electric circuit board E1 and the metal layer M1, a photosensitive resin which is a material for the formation of the first cladding layer 6 is initially applied to the back surface (the lower surface as seen in the figure) of the laminate, as shown in FIG. 3A. Thereafter, the applied layer is exposed to irradiation light. This exposure cures the applied layer to form the first cladding layer 6. The first cladding layer 6 is formed while filling the site where the metal sheet material Ma (with reference to FIG. 2C) is removed (the portion S on the longitudinally second end portion side) and the through hole 5 for an optical path formed in the metal layer M1. The first cladding layer 6 has a thickness (a thickness as measured from a back surface of the metal layer M1) in the range of 5 to 80 μm, for example. It should be noted that the back surface of the laminate is positioned to face upward when the optical waveguide W1 is formed (when the aforementioned first cladding layer 6, the core 7 to be described later and the second cladding layer 8 to be described later are formed).

Next, as shown in FIG. 3B, the core 7 having a predetermined pattern is formed on a front surface (a lower surface as seen in the figure) of the first cladding layer 6 by a photolithographic process. The second end portion of the core 7 is formed into a surface perpendicular to the longitudinal direction of the core 7, and serves as the connection surface 7c for connection to an end surface of the core 9 (with reference to FIG. 1) of the optical fiber F. The core 7 has the following dimensions: a width in the range of 5 to 200 μm, and a thickness in the range of 5 to 200 μm. An example of a material for the formation of the core 7 includes a photosensitive resin similar to that for the first cladding layer 6, and the material used in the core has a refractive index higher than that of the materials for the formation of the aforementioned first cladding layer 6 and the second cladding layer 8 to be described below (with reference to FIG. 3C).

Next, as shown in FIG. 3C, the second cladding layer 8 is formed on the front surface (the lower surface as seen in the figure) of the first cladding layer 6 by a photolithographic process so as to cover the core 7. The second cladding layer 8 has a thickness (a thickness as measured from the front surface of the first cladding layer 6) greater than that of the core 7, e.g. not greater than 500 μm. An example of the material for the formation of the second cladding layer 8 includes a photosensitive resin similar to that for the first cladding layer 6.

Thereafter, as shown in FIG. 3D, a portion (the first end portion) of the core 7 which corresponds to the mounting pads 2a of the electric circuit board E1 (positioned under the mounting pads 2a as seen in the figure) together with the first cladding layer 6 and the second cladding layer 8 is formed into an inclined surface inclined at 45 degrees with respect to the longitudinal direction of the core 7, for example, by excimer laser beam machining. The portion of the core 7 positioned at the inclined surface serves as the light reflecting surface 7a and 7b.

<Inspection of Degree of Curvature of Light Reflecting Surfaces 7a and 7b in Step of Forming Optical Waveguide W1>

The degree of curvature (the degree of flatness) of the light reflecting surfaces 7a and 7b formed in the first end portion of the core 7 is inspected in a manner to be described below. This inspection method is a first property of the present disclosure.

As shown in FIG. 4, a light source 10 such as an LED (light-emitting diode) which emits uniform light, and a camera 20 including an imaging device such as a CCD (charge-coupled device) image sensor or a CMOS (complementary metal oxide semiconductor) image sensor are initially prepared in the method of inspecting the degree of curvature of the light reflecting surfaces 7a and 7b. The light source 10 is placed on the connection surface 7c side in the second end portion of the core 7, and the camera 20 is placed over a portion of the electric circuit board E1 which corresponds to the light reflecting surface 7a and 7b in the first end portion of the core 7. Next, light L1 is emitted from the light source 10 toward the connection surface 7c in the second end portion of the core 7.

Thus, the light L1 enters the core 7 by way of the connection surface 7c in the second end portion of the core 7, and is then reflected from the light reflecting surface 7a and 7b in the first end portion, so that the optical path of the light L1 is changed by 90 degrees. Then, the light L1 is propagated toward the camera 20. Subsequently, the light L1 exits the core 7, and then passes through the first cladding layer 6, through the through hole 5 for an optical path formed in the metal layer M1 and through the insulative layer 1 in the order named. Thereafter, the light L1 exits toward the camera 20.

Next, the exiting light L1 is imaged by the imaging device of the camera 20. Then, the brightness of the exiting light L1 is measured by determining the brightness of the obtained image. During the imaging of the exiting light L1 (during the measurement of the brightness), the camera 20 may be focused on a portion of the light reflecting surface 7a and 7b in the first end portion of the core 7 (for example, on an upper end edge of the light reflecting surface 7b). Alternatively, the focus of the camera 20 may be shifted away from the light reflecting surface 7a and 7b in the direction of the camera 20 or in the opposite direction (from the light reflecting surface 7a and 7b in the direction opposite from the camera 20).

The degree of curvature of the light reflecting surface 7a and 7b is inspected based on the measurement value of brightness. It is judged that the extent of spread of the light L1 reflected from the light reflecting surface 7a and 7b decreases and the degree of curvature of the light reflecting surface 7a and 7b accordingly decreases as the measurement value of brightness increases. Thus, a product having a measurement value of brightness greater than a previously set reference value includes the light reflecting surface 7a and 7b nearly flat enough for practical use, and is judged as an accepted product as a result of the inspection.

For example, when the imaging device is a CCD image sensor and the exiting light L1 is imaged by the CCD image sensor, light-receiving pixels of the CCD image sensor receive the exiting light L1, and a brightness value is measured for each of the light-receiving pixels. A predetermined threshold value (for example, 500) is set for the brightness value, and the number of light-receiving pixels having measured the brightness value equal to or greater than the threshold value is counted. The counted number is defined as an area integrated value. It is judged that the degree of curvature of the light reflecting surfaces 7a and 7b decreases as the area integrated value increases. The threshold value for the brightness value is, for example, in the range of 10 to 2000, preferably in the range of 100 to 1000, and more preferably in the range of 300 to 700.

In this manner, the optical waveguide W1 is formed by undergoing the step of inspecting the degree of curvature of the light reflecting surfaces 7a and 7b. It is a second property of the present disclosure that the step of inspecting the degree of curvature of the light reflecting surfaces 7a and 7b is provided in this manner in the step of forming the optical waveguide W1 and that the optical waveguide W1 including the light reflecting surfaces 7a and 7b having a degree of curvature suitable for practical use is judged as an accepted product.

[Mounting of Light-Emitting Element 11 and Light-Receiving Element 12 of Opto-Electric Hybrid Boards A and B]

Then, the light-emitting element 11 or the light-receiving element 12 (with reference to FIG. 1) is mounted on the mounting pads 2a of the electric circuit board E1 stacked on the optical waveguide W1 judged as an accepted product as a result of the inspection. In this manner, the opto-electric hybrid board A including the light-emitting element 11 and the opto-electric hybrid board B including the light-receiving element 12 are provided.

Then, the connection surface 7c of the core 7 of the opto-electric hybrid board A including the light-emitting element 11 is connected to the first end portion of the core 9 of the optical fiber F, and the connection surface 7c of the core 7 of the opto-electric hybrid board B including the light-receiving element 12 is connected to the second end portion of the core 9 of the optical fiber F. Thus, the opto-electric hybrid module shown in FIG. 1 is provided.

In this manner, the step of forming the optical waveguide W1 includes the step of inspecting the degree of curvature of the light reflecting surfaces 7a and 7b. Thus, the light-emitting element 11 and the light-receiving element 12 are prevented from being mounted on the electric circuit board E1 stacked on the optical waveguide W1 that is a rejected product having a high degree of curvature of the light reflecting surfaces 7a and 7b. This prevents the light-emitting element 11 and the light-receiving element 12 which function normally from being discarded due to the mounting of the light-emitting element 11 and the light-receiving element 12 on the electric circuit board E1 stacked on the optical waveguide W1 that is a rejected product.

FIG. 5 is a vertical sectional view of another embodiment of the opto-electric hybrid boards including the optical waveguide to be inspected by the method of inspecting an optical waveguide according to the present disclosure. An opto-electric hybrid board according to this embodiment is configured such that the opto-electric hybrid boards A and B in the opposite end portions of the opto-electric hybrid module in the aforementioned embodiment shown in FIG. 1 are directly connected together without the optical fiber F connected therebetween. In FIG. 5, the reference character E2 designates an electric circuit board, M2 designates a metal layer, and W2 designates an optical waveguide. The remaining parts are similar to those of the aforementioned embodiment shown in FIG. 1, and like reference numerals and characters are used to designate similar parts.

The electric circuit board E2, the metal layer M2 and the optical waveguide W2 are formed in steps similar to those of the aforementioned embodiment shown in FIG. 1. In this embodiment, the degree of curvature of the light reflecting surfaces 7a and 7b in the opposite end portions of the optical waveguide W2 is inspected in the same manner as in the aforementioned embodiment shown in FIG. 1.

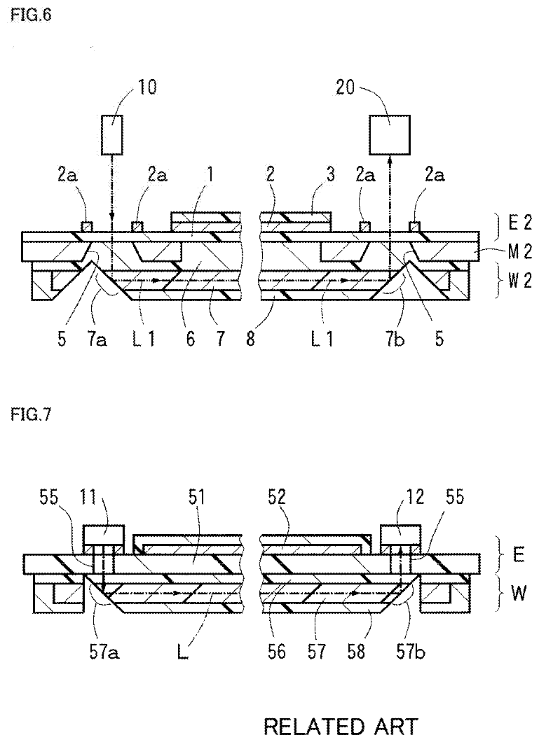

Specifically, the method of inspecting the degree of curvature of the light reflecting surface 7b is as follows. As shown in FIG. 6, the light source 10 such as an LED is placed over a portion of the electric circuit board E2 which corresponds to the first light reflecting surface 7a of the core 7 and which is positioned on the side where the light-emitting element 11 is to be mounted, and the camera 20 is placed over a portion of the electric circuit board E2 which corresponds to the second light reflecting surface 7b of the core 7. Next, light L1 is emitted from the light source 10 toward the first light reflecting surface 7a of the core 7.

Thus, the light L1 is reflected from the first light reflecting surface 7a, and is propagated in the core 7. Thereafter the light L1 is reflected from the second light reflecting surface 7b, and exits toward the camera 20. Next, the exiting light L1 is imaged by the camera 20, so that the brightness of the exiting light L1 is measured. Then, the number of light-receiving pixels having measured the brightness value equal to or greater than the threshold value is counted in the aforementioned manner. The counted number is defined as the area integrated value. The degree of curvature of the second light reflecting surface 7b is inspected based on the area integrated value.

Also, the measurement is made in the same manner after the optical waveguide W2 shown in FIG. 6 is flipped horizontally. Thus, the degree of curvature of the first light reflecting surface 7a is inspected.

Thereafter, the light-emitting element 11 and the light-receiving element 12 (with reference to FIG. 5) are mounted on only the electric circuit board E2 stacked on the optical waveguide W2 accepted as a result of the aforementioned inspection. Thus, the opto-electric hybrid board shown in FIG. 5 is provided.

In the aforementioned embodiments, the inspection of the degree of curvature of the light reflecting surfaces 7a and 7b is performed only on the electric circuit boards E1 and E2 in which the electrical interconnect lines (the electrical interconnect line body 2 and the mounting pads 2a) are formed. However, the inspection of the degree of curvature of the light reflecting surfaces 7a and 7b may be performed on electric circuit boards in which the electrical interconnect lines are not formed.

Next, examples of the present disclosure will be described. It should be noted that the present disclosure is not limited to the examples.

### EXAMPLES

OCT-001 available from Synergy Optosystems Co., Ltd. was prepared as a brightness measuring device. A source of light entering a core which was used herein had an emitted light wavelength of 850 nm, a uniform light irradiation surface diameter of 4 mm, and a NA (numerical aperture) of 0.57. A CCD image sensor of a camera for imaging light exiting an optical waveguide which was used herein had a magnifying power of 5 times, a field of view in the range of 1.28 mm×0.96 mm, and a NA (numerical aperture) of 0.42.

Prepared were fifteen samples of the optical waveguide (with reference to FIG. 1) in which a light entrance surface (a connection surface) was formed in a second end portion of the core and a light reflecting surface was formed in a first end portion of the core. The core had the following dimensions: a rectangular cross-section measuring 50 μm×50 μm; a length of 3 mm; and a distance of 250 μm between adjacent cores. Light emitted from the light source was caused to enter the core by way of the light entrance surface in the second end portion of the core, to reflect from the light reflecting surface in the first end portion thereof, and to exit the optical waveguide.

### Example 1

The focus of the camera was adjusted to an upper end edge of the light reflecting surface of each sample, and the light exiting one core was imaged by the camera in that state (focused state). The threshold value of the brightness value measured in light-receiving pixels of the CCD image sensor was set to 500, and the number of light-receiving pixels having measured the brightness value equal to or greater than the threshold value was counted. This process performed between imaging using the camera and counting the number of light-receiving pixels was repeated four times. The sum total was defined as an area integrated value, which was listed in TABLE 1 below.

### Example 2

While the focal length of the camera was maintained in Example 1, the camera was moved 160 μm away from the light reflecting surface of each sample. That is, the focus of the camera was at a position 160 μm closer to the camera with respect to the upper end edge of the light reflecting surface of each sample. The light exiting the core was imaged by the camera in that state (defocused state). Then, the area integrated value was calculated in the same manner as in Example 1, and was listed in TABLE 1 below.

[Evaluation of Curvature of Light Reflecting Surface (Evaluation Using Area Integrated Value)]

A reference product serving as a standard of comparison was prepared. The reference product in Example 1 had an area integrated value of 4364. Using this area integrated value as a reference value, a value of 4000 obtained by decreasing the reference value by approximately 10% was defined as a threshold value. Each sample having the area integrated value not less than the threshold value of 4000 was evaluated as “o: the light reflecting surface had a low degree of curvature”, and each sample having the area integrated value less than the threshold value of 4000 was evaluated as “x: the light reflecting surface had a high degree of curvature”. These evaluations were listed in TABLE 1 below. The reference product in Example 2 had an area integrated value of 12251. Using this area integrated value as a reference value, a value of 11000 obtained by decreasing the reference value by approximately 10% was defined as a threshold value. Each sample having the area integrated value not less than the threshold value of 11000 was evaluated as “∘: the light reflecting surface had a low degree of curvature”, and each sample having the area integrated value less than the threshold value of 11000 was evaluated as “x: the light reflecting surface had a high degree of curvature”. These evaluations were listed in TABLE 1 below.

[Measurement of Radius of Curvature of Light Reflecting Surface and Evaluation Using Scanned Image]

Using VKX-250 available from Keyence Corporation, the light reflecting surface of each example of the optical waveguide was scanned with laser light, so that an image of the light reflecting surface was acquired. By analyzing the image, the radius of curvature of the actual light reflecting surface was determined. Each sample having a radius of curvature of not less than 200 μm was evaluated as “∘: the light reflecting surface had a low degree of curvature”, and each sample having a radius of curvature of less than 200 μm was evaluated as “x: the light reflecting surface had a high degree of curvature”. These evaluations were listed in TABLE 1 below.

TABLE 1

| | | | | | Evalu- |
|---|---|---|---|---|---|
| | Example 1 | | Example 2 | | ation of |
| | Focused position | | Defocused position | | curvature |
| | Area | | Area | | using |
| | integrated | Evalu- | integrated | Evalu- | scanned |
| Sample | value | ation | value | ation | image |
| Reference | 4364 | — | 12251 | — | ∘ |
| product | | | | | |
| No. 1 | 3882 | x | 10090 | x | x |
| No. 2 | 3686 | x | 9896 | x | x |
| No. 3 | 2595 | x | 7173 | x | x |
| No. 4 | 3624 | x | 9559 | x | x |
| No. 5 | 3418 | x | 9062 | x | x |
| No. 6 | 2966 | x | 8281 | x | x |
| No. 7 | 2804 | x | 7999 | x | x |
| No. 8 | 3277 | x | 9510 | x | x |
| No. 9 | 5604 | ∘ | 12190 | ∘ | ∘ |
| No. 10 | 6268 | ∘ | 13065 | ∘ | ∘ |
| No. 11 | 5862 | ∘ | 13207 | ∘ | ∘ |
| No. 12 | 4317 | ∘ | 11870 | ∘ | ∘ |
| No. 13 | 4851 | ∘ | 12387 | ∘ | ∘ |
| No. 14 | 5499 | ∘ | 13371 | ∘ | ∘ |
| No. 15 | 5498 | ∘ | 13571 | ∘ | ∘ |

As indicated in TABLE 1, the degree of curvature of the light reflecting surface inspected by the inspection methods of Examples 1 and 2 coincided with the evaluation using the image of the light reflecting surface actually obtained by scanning with laser light. That is, it was found that the inspection of the degree of curvature of the light reflecting surface was achieved by the simple and easy inspection methods of Examples 1 and 2.

Also, the inspection methods of Examples 1 and 2 were adopted into the step of forming the optical waveguide. As a result, this facilitated the inspection as to how high or low the degree of curvature of the light reflecting surface was.

Although specific forms in the present disclosure have been described in the aforementioned examples, the aforementioned examples should be considered as merely illustrative and not restrictive. It is contemplated that various modifications evident to those skilled in the art could be made without departing from the scope of the present disclosure.

The method of inspecting an optical waveguide and the method of manufacturing an optical waveguide using the same according to the present disclosure are applicable to inspecting the degree of curvature of the light reflecting surface formed in the core of the optical waveguide in a simple and easy manner.

### REFERENCE SIGNS LIST

L1 Light
W1 Optical waveguide
7 Core
7a and 7b Light reflecting surfaces
7c Connection surface
10 Light source
20 Camera

1. A method of inspecting an optical waveguide, comprising the steps of:
preparing an optical waveguide including a linear core for an optical path, the core having a first end portion in which a light reflecting surface for changing an optical path is formed;
causing light to enter the core by way of a second end portion of the core, to reflect from the light reflecting surface and to exit the optical waveguide; and
measuring a brightness of the exiting light,
wherein a degree of curvature of the light reflecting surface is inspected based on a measurement value of the brightness.

2. The method of inspecting an optical waveguide according to claim 1, further comprises:
setting a reference value of the brightness; and then
comparing the measurement value of the brightness with the reference value, in the curvature inspection based on the measurement value of the brightness.

3. The method of inspecting an optical waveguide according to claim 1, wherein the measurement of the brightness is made by using a camera including an imaging device to image the light exiting the optical waveguide, while the focus of the camera is adjusted to a portion of the light reflecting surface, and then determining a brightness of an obtained image.

4. The method of inspecting an optical waveguide according to claim 1, wherein the measurement of the brightness is made by using a camera including an imaging device to image the light exiting the optical waveguide, while the focus of the camera is shifted away from the light reflecting surface, and then determining a brightness of an obtained image.

5. A method of manufacturing an optical waveguide, comprising the steps of:
forming a core;
forming a first end portion of the core into a light reflecting surface; and
inspecting a degree of curvature of the light reflecting surface with the method of inspecting an optical waveguide as recited in claim 1,
wherein an optical waveguide meeting a standard is judged as an accepted product, based on a result of the inspection.
